(19) United States
(12) Patent Application Publication
(10) Pub. No.: US 2006/0007856 A1
(43) Pub. Date: Jan. 12, 2006

(54) Backpressure method on multiplexed links

(75) Inventor: Gerald Berghoff, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/941,988

(22) Filed: Sep. 16, 2004

(30) Foreign Application Priority Data
Jul. 7, 2004 (EP) 04 013-408.2

(51) Int. Cl. H04L 12/26

(52) U.S. Cl. 370/229

(57) ABSTRACT

The invention proposes a network element comprising a first network block (1) and a second network block (2) connected via a link (3) providing a certain data rate, wherein the first network block comprises at least one data source (11-1 to 11-n) and at least one data rate limiting means (12-1 to 12-n) associated to the data source, the second network block comprises at least one data processing means (22-1 to 22-n) associated to the data source, and a data flow information obtaining means (23-1 to 23-n) for obtaining data flow information regarding the data rate of the data processed by the data processing means, wherein the data rate limiting means of the first network block is adapted to vary the data rate of data sent from the data source depending on the data flow information. The invention also proposes a corresponding method.

### BACKGROUND OF THE INVENTION

1. Field of the Invention

The invention relates to a method for controlling data flow from a first network block to a second network block connected via a link providing a certain data rate, and a corresponding network element comprising the first network block and the second network block.

2. Description of the Related Art

This invention is related to an equipment or network architecture that performs data forwarding between a data source and a data sink via a multiplexed transmission interface. There are various types of transmission interfaces for the connection of data sources and data sinks (that may be implemented as physically different modules). Some of them provide a flow control mechanism, some of them don't. The present invention is related to the latter type and is directed to the problem of a missing flow control.

In the following, the considered architecture is described by referring to FIG. 1. The architecture can be part of an IP (Internet Protocol) router or an MPLS (Multiprotocol Label Switching) switching router, for example. The architecture comprises two functional blocks: first, a “Layer 3 block” (L3 block). This block contains several sources for data packets (these may be e.g. DiffServ (Differentiated Services) schedulers for IP packets). Second, a “Layer 2 block” (L2 block), that contains several processing blocks that receive packets from the L3 block and forward them to network interfaces towards a public network on which the data packets are finally transmitted. The L2 block performs PPP/HDLC (Point-to-Point Protocol/High Level Data Link Control) encapsulation and processing. Each source in the L3 block transmits to exactly one PPP/HDLC transmitter and one network interface in the L2 block.

The L3 block and the L2 block are interconnected via an Ethernet interface. In order to distinguish data packets from the different L3 sources, a logical multiplexing is done based on the VLAN Ethernet header. The Ethernet interface has a much higher throughput than the aggregated throughput of the Network Interfaces. For this reason, each L3 data packet source is followed by a rate limiter. This rate limiter limits the number of transmitted bytes per time unit, so that the data rate from L3 source to the associated PPP/HDLC block does not exceed the maximum throughput of the network interface. Limiting the data rate is performed in its basic form by inserting time intervals between subsequent packets, for example.

Only the transmit direction (TX) is relevant in this context (from data sources to network interfaces). The receive direction does not exhibit the problem stated below that is addressed by the present invention.

PPP/HDLC processing (transmit direction) in L2 adds bits or bytes (depends on the operational mode) to the payload of the data packets (bit/byte stuffing). The number of added bits or bytes depends on the bit pattern of the payload and can not be predicted without inspecting the payload of each packet. The effective amount of data to be transmitted on the network interface is increased, or in other words, the effective available throughput of the network interface, as perceived by the L3 block, is reduced.

The problem is that this decrease of effective throughput is not predictable by the L3 sources block (unless they inspect the payload of each packet, which is a considerable effort). That is, there is more or less time needed for transmission on the network interfaces which is not predictable. If the rate limiter only takes into account the number of bytes of the original payload, the network interface will be over-subscribed, and packet loss will occur in the L2 block. If the rate limiter tries to take into account the PPP/HDLC bit/byte stuffing by setting the data rate well below the nominal network interface throughput, capacity is wasted.

The problem was solved earlier by limiting the data rate in the L3 block to a value low enough so that even with worst case bit/byte stuffing in the L2 block, the transmit capacity of the network interface is not exceeded. Result is that transmit capacity on network interfaces is not efficiently used.

It is noted that this problem does not only exist in the above-described L3/L2 architecture, but may occur in other structures in which a device X supplies data to a device Y via a multiplexed (shared) interface. Device Y processes this data further in a not exactly predictable speed (e.g., transmits it via a network interface or the like). The link between the two devices allows a higher data rate than the rate at which the data is further processed in device Y. Device X includes individual rate limiter (also referred to as rate shaper) functions for each processing block of device Y, in order to limit the amount of data transmitted, so that the available transmission capacity of the subsequent interface is never exceeded. Due to not predictable available transmit capacity variation of the interfaces in device Y (resulting from e.g. stuffing operations), and addition of variable header information from the data to be transmitted in device Y, the achievable throughput compared to the available capacity is lower, because some margin for those non predictable capacity variations must be left by the rate shaper in device X belonging to the interface in device Y (a typical value is 10% of the available transmission capacity).

### SUMMARY OF THE INVENTION

Hence, it is an object of the invention to remove the above drawback such the maximum possible data rate can be fully exploited.

This object is solved by a network element comprising

a first network block and a second network block connected via a link providing a certain data rate, wherein

the first network block comprises at least one data source and at least one data rate limiting means associated to the data source,

the second network block comprises at least one data processing means associated to the data source, and a data flow information obtaining means for obtaining data flow information regarding the data rate of the data processed by the data processing means,

wherein the data rate limiting means of the first network block is adapted to vary the data rate of data sent from the data source depending on the data flow information.

Alternatively, the above object is solved by a method for controlling data flow from a first network block to a second network block connected via a link providing a certain data rate, comprising the steps of

sending data received from a a data source of the first network block via the link from the first network block to the second network block,

processing the data received via the link in the second network block,

obtaining data flow information regarding the data rate of the data processed by the data processing means, and

varying the data rate of data sent from the data source of the first network block to the data link depending on the data flow information.

Furthermore, the above object is solved by a network block comprising at least one data source, at least one data rate limiting means associated to the data source and a data sending means, wherein the data rate limiting means is adapted to vary the data rate of data sent from the data source depending on data flow information.

As a further alternative, the above object is solved by a network block comprising a data receiving means, at least one data processing means associated to the data, and a data flow information obtaining means for obtaining data flow information regarding the data rate of the data processed by the data processing means, wherein the data flow information obtaining means is adapted to provide the data flow information for varying the data rate.

Hence, according to the invention, information regarding a data rate used in the second network block/element (in the following also referred to as backpressure information) is supplied to the rate limiter in the first network block/element, so that the data rate is varied based on the backpressure information.

Thus, the maximum data rate achievable in the second network block/element by the means which is determinant for the data rate can be fully exploited. For example, in case the second network block provides a network interface and the data processing means prepares the data for it, the maximum interface capacity can be exploited to 100%, without any packet loss.

Moreover, according to the present invention, only the data rate is adapted. That is, depending on the backpressure information, the data rate is increased or decreased, but never set to zero. Hence, the traffic is never interrupted. That is, according to the invention a smooth communication is possible.

It is noted that the terms “network element” or “network block” refer to any kind of “module”, “unit”, “functional block of a system” in a network.

A plurality of data streams may be provided and each data stream may be associated with one data source and one data rate limiting means of the first network block, and with one data processing means and one data flow information obtaining means and one network interface of the second network block.

The link may be a multiplexed link, and the plurality of data streams is transferred via the multiplexed link between the first network block and the second network block. The multiplexed link may be an Ethernet link, and the multiplexing technique applied to the Ethernet link may be Virtual Local Area Network (VLAN) Ethernet.

For obtaining the data flow information, a buffering means and a buffer level detecting means may be used, wherein the data flow information comprises information regarding the buffer filling level.

At least a first threshold may be provided for the buffer filling level, and the data flow information obtaining means may be adapted to include information whether the threshold is exceeded in the data flow information. The information whether the first threshold is exceeded may be included in a data flow message and the data flow message may be sent only when the first threshold is exceeded. The data rate may be decreased in case the first threshold is exceeded.

A second threshold may be provided for the buffer filling level, wherein the data flow information obtaining means is adapted to include information whether the buffer filling level has fallen below the second threshold in the data flow information. The above first and second thresholds may be both applied, wherein the second threshold is lower than the first threshold.

The data rate may be increased in case the data rate has fallen below the second threshold.

The information whether the buffer filling level has fallen below the second threshold may be included in a data flow message, and the data flow message may be sent only when the buffer filling level has fallen below the second threshold.

### BRIEF DESCRIPTION OF THE DRAWINGS

The invention is described by referring to the enclosed drawings showing only the TX direction, in which:

FIG. 1 shows an architecture consisting of a L3 block, a L2 block and an Ethernet interface between them that is used in a multiplexed manner;

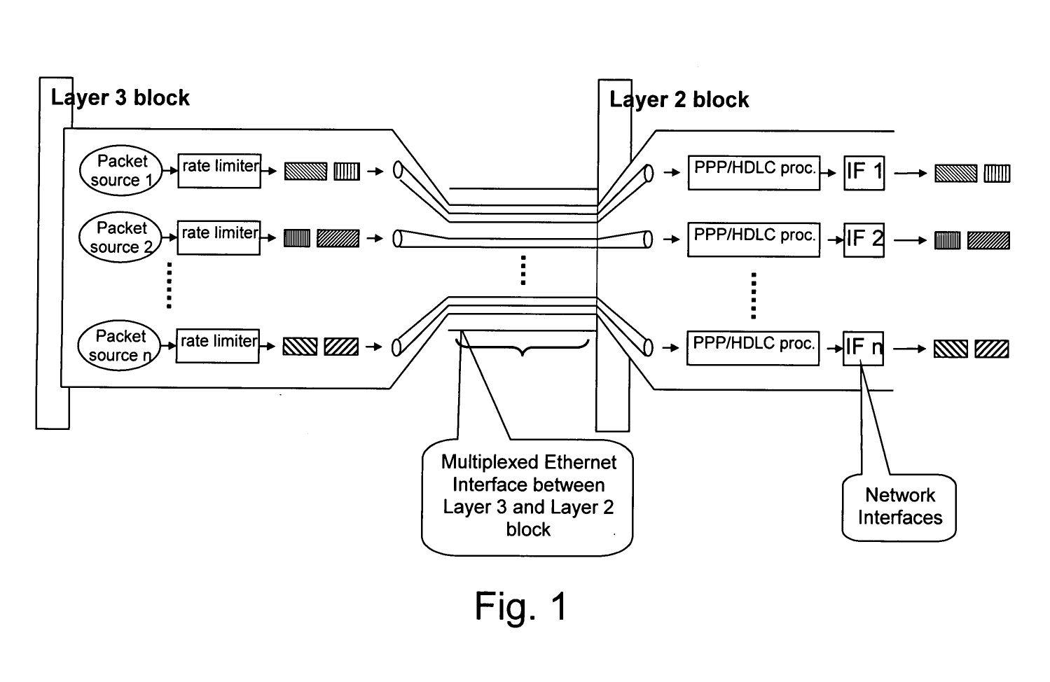

FIG. 2 shows a block diagram illustrating the structure according to a preferred embodiment of the present invention;

FIG. 3 illustrates a detailed view on the L2 block according to the preferred embodiment, and

FIG. 4 shows a flowchart of a procedure for controlling a rate limiter correspondingly to backpressure information according to the preferred embodiment of the present invention.

### DETAILED DESCRIPTION OF THE PREFERRED EMBODIMENTS

In the following, preferred embodiments of the present invention are described by referring to the attached drawings.

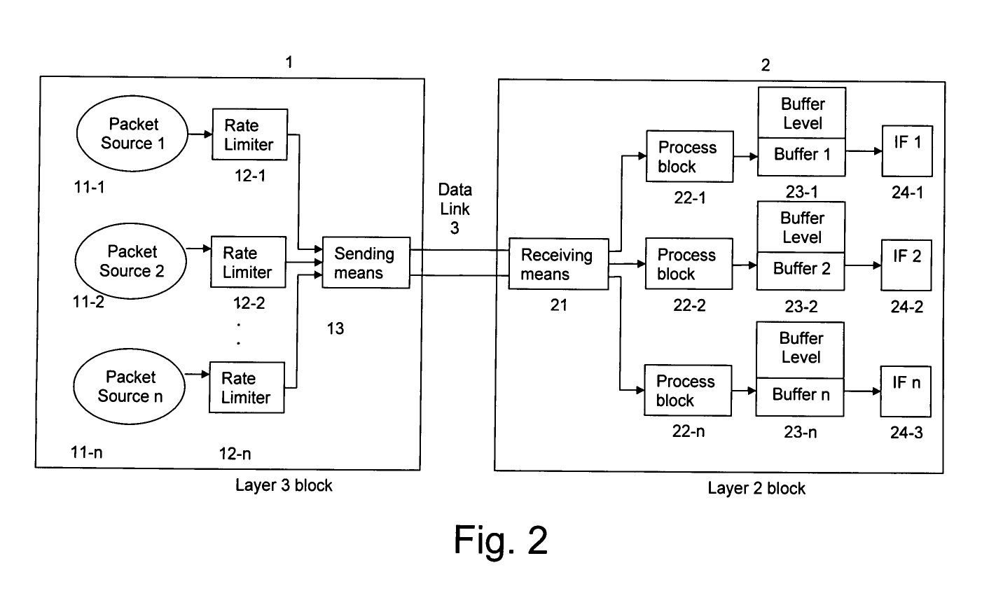

The general structure of a network element according to the embodiment of the present invention is described in the following by referring to FIG. 2.

A network element comprises a L3 block as an example for a first network block 1 and a L2 block as an example for a second network block 2. Both blocks are connected via a data link 3. An example for such a data link is an Ethernet interface. It is noted that this link provides a certain data rate that is larger than the aggregated data rate of the interfaces on the L2 block. The L2 block comprises data sources (e.g., packet sources) 11-1 to 11-n and data rate limiting means 12-1 to 12-n. Each of the data rate limiting means is associated to a particular data source (e.g., 11-1 to 12-1, as indicated in the drawing). It is noted that at least one of the data sources and the data rate limiting means have to be provided. A sending means 13 sends the data over the interface 3.

The L2 block 2 comprises a receiving means 21 which receives data from the interface 3. Data processing means 22-1 to 22-n are provided (correspondingly to the data sources 11-1 to 11-n in the L3 block 1). Furthermore, buffers 23-1 to 23-n each comprising a buffer filling level detecting means are provided. The buffers 23-1 to 23-n are connected to network interfaces 24-1 to 24-n, respectively.

It is noted that one packet source, one rate limiter, one data processing means, one buffer and one interface are respectively associated to each other, so that they conduct one data stream. For example, a first data stream is conducted via the packet source 11-1, the rate limiter 12-1, the buffer 23-1 and the interface 24-1. The interface 3 is in this example an Ethernet interface, as mentioned above, and the sending means 13 of the L3 block performs a multiplexing of the data streams, whereas the receiving means 21 of the L2 block performs a de-multiplexing of the data streams.

The buffer filling level detectors associated to each buffer 23-1 to 23-n are examples for data flow information obtaining means which are obtaining data flow information regarding the data rate of the data processing means, e.g., the data rate which can actually be exploited by the interfaces. This information is supplied to the corresponding rate limiters of the L3 block, wherein rate limiter varies the data rate depending on the data flow information.

The rate limiter varies the data rate by inserting time gaps between subsequent packets, for example. That is, in order to decrease the data rate, the rate limiter extends the gaps between subsequent packets, whereas in order to increase the data rate, the gaps between the subsequent packets are shortened.

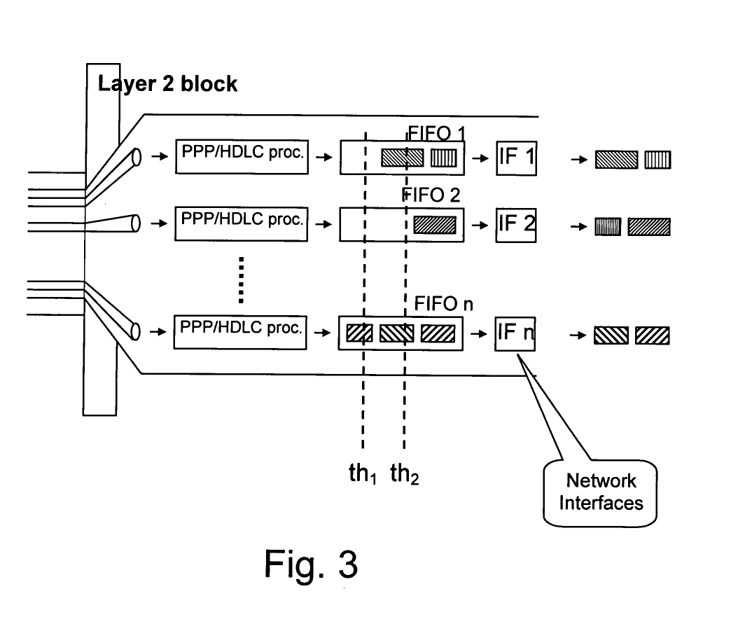

The general structure and operation according to the embodiment described above is described in the following in more detail also by referring to FIG. 3 which shows a more detailed structure of the L2 block, wherein PPP/HDLC processing blocks, FIFO buffers and associated thresholds are illustrated.

For simplifying the description, the mechanism of only one Packet source/rate limiter/network interface is described. All other interfaces work with more implementations of the same mechanism. As shown in FIG. 3, the L2 block further comprises PPP/HDLC processing blocks for each data stream. The buffers 23-1 to 23-n shown in FIG. 2 are in this examples FIFOs (First-In-First-Out) buffers. For these FIFOs, two thresholds th₁ and th₂ are defined which are monitored by the buffer filling level detectors.

The L3 rate limiter (i.e., 12-1 to 12-n) works with two different rates: one is the nominal rate of the network interface (taking into account the predictable part of the PPP/HDLC encapsulation which is the additional header). Working with this rate ensures that in case of no bit/byte stuffing (because it may not be required due to the payload pattern), the network interface capacity is fully exploited. If there is bit/byte stuffing because of the payload pattern, then the FIFO buffer slowly fills up. When the first threshold th, is exceeded, an information is sent to the L3 block, and the corresponding rate limiter starts to work with a rate that is well below the nominal network interface capacity. This rate is chosen in such a way that even with maximum bit/byte stuffing, the filling level of the FIFO buffer is not increasing, i.e., in non-worst cases, the filling level decreases. When the filling level has fallen below the second threshold th₂ which is smaller than the first threshold th₁, then the L3 block is informed again, and the rate of the rate limiter is, again, set to the nominal rate of the network interface (and the FIFO buffer starts to fill up, and so forth).

The FIFO buffers and the threshold values are shown in FIG. 3. In this example, FIFO 1 is filled between th₂ and th₁. This means that the rate of the corresponding rate limiter does not need to be changed (it is either the higher rate, and filling level is increasing; or it is the lower rate, and filling level is decreasing). FIFO 2 is filled below th₂. This means that the rate limiter's rate should be changed to the higher rate. FIFO 3 is filled higher than th₁. This means that the rate limiter's rate must be changed to the lower rate, in order to make the filling level decrease.

The information about FIFO buffer filling levels is transported in special messages (“backpressure messages”) from the L2 block to the L3 block. These messages are distinguished from the normal payload packets either by a dedicated value for a VLAN (Virtual Local Area Network) tag in the VLAN Ethernet header, or by using a standard Ethernet header (potentially with a proprietary value for the Ethertype field).

The backpressure messages may contain filling level information for one network interface only, or they may contain filling level information for all network interfaces of the L2 block. The information that is transferred to the L3 block may be either just of the type “th₁ exceeded” (in this case, the L2 block compares actual filling level and threshold value), or it may give the actual filling level in number of bytes (in this case, the L3 block compares actual filling level and threshold value).

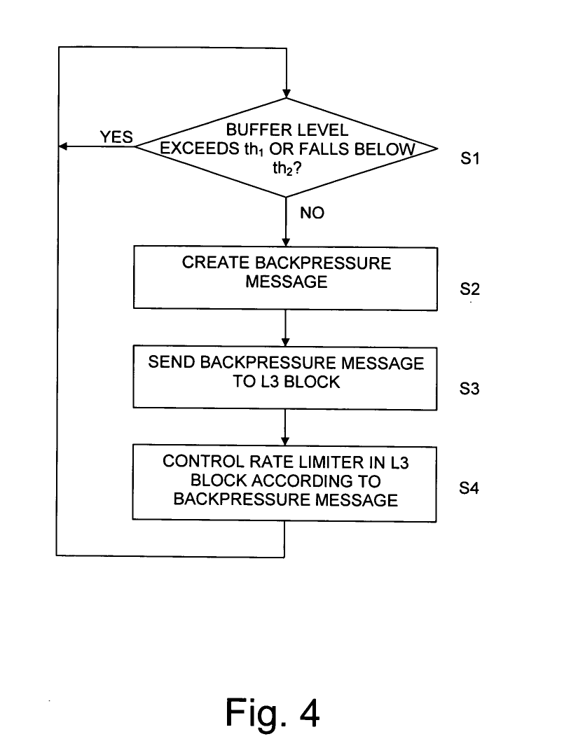

This mechanism is summarized in the following by referring to the flowchart shown in FIG. 4. The procedure shown in FIG. 4 is carried out permanently. This is illustrated by the loop shown in FIG. 4. For simplifying the description and the illustration, the procedure is described for one data stream only.

In detail, in step S1 it is checked whether the buffer filling exceeds the first threshold th₁ or falls below the threshold th₂ described above. If the buffer filling level does not exceed the first threshold or falls below the threshold, i.e., is within the range, step S1 is repeated. If the buffer filling level, however, exceeds the first threshold th₁ or falls below the second threshold th₂, the process proceeds to step S2, in which a backpressure message comprising information that the data rate should be changed is created. This backpressure message is forwarded to the L3 block in step S3, and in more detail to the rate limiter. In step S4, the rate limiter in the L3 block is controlled according to the backpressure information included in the backpressure message, as described above.

It is noted that the process of step S1 is only illustrative. As an alternative, instead of monitoring exceeding the threshold or falling below the threshold, it is also possible to continuously monitor the buffer filling level, such as whether the buffer filling level is in a range between the first threshold th₁ and the second threshold th₂.

Thus, as described above, according to the invention a mechanism is provided that provides backpressure information to implement flow control for independent data streams transferred via one multiplexed (Ethernet) link in order to overcome the problem underlying the present invention. In particular, separate flow control (backpressure) mechanisms are used for each individual data stream in the multiplexed link. Furthermore, the transmit data rate of each rate limitier (also referred to as rate shaper) is toggled between 2 configurable rates. The lower one leading to a receiver buffer fill decrease, the higher one to a receiver buffer fill increase. That is, the rate of each L3 rate limiter is dynamically adapted (toggled between a higher rate and a lower rate), depending on the filling level of L2 FIFO buffers and the status of associated thresholds. This information is communicated to the L3 rate limiters by dedicated in-band messages. The result is that available capacity of the network interfaces is exploited in an optimum way, and no packets are dropped. The invention supports optimal transmit capacity usage, because extra capacity needed e.g. for stuffing operations needs not to be reserved.

Compared to other known backpressure/flow control solutions transmission is never stopped. This improves delay variation and jitter behaviour.

The advantage of 100% capacity utilisation without packet loss is not possible with standard Ethernet flow control in cases of logical multiplexing. This allows more freedom in the architectural design of network elements and the use of inexpensive, standardized Ethernet interfaces between separate functional blocks.

It is noted that the invention is not limited to the embodiments described above, which should be considered as illustrative and not limiting. Thus, many variations of the embodiments are possible.

For example, the above embodiment is directed to a L3/L2 structure. However, the invention is not limited to this architecture, but can be applied whenever a first network block supplies data to a second network block with a higher data rate than the rate which the second network block is capable to process. In particular, the invention is not limited to a network interface of the second network block, but also other data processing means are possible.

In particular, the two network blocks described above can be separate network elements within a network. That is, in this case the invention is directed to a network system comprising two network elements which are connected via a link, wherein the two network elements are independent from each other.

Furthermore, in the above embodiment two thresholds th₁ and th₂ are applied. However, alternatively only one threshold can be applied. Namely, in case only the upper threshold th₁ is used, the data rate is reduced by the rate limiter whenever the buffer filling level exceeds the threshold, and the rate limiter resumes limiting data rate to the nominal rate when the buffer filling level does not exceed the threshold anymore. This would lead to a higher frequency of backpressure messages and more frequent changes of the data rate, on the other hand the structure of the buffer can be simplified since only one threshold has to be monitored.

Moreover, the invention is not limited to a multiplexed Ethernet between the two network blocks concerned, but any suitable link mechanism can be applied.

Furthermore, the invention is not limited to a VLAN structure as described above.

The data processing is not limited to the PPP/HDPLC processing, but any kind of “data processing” can be applied in which the amount of data after data processing can not be predicted by the data source but varies.

1. A network element comprising
a first network block and a second network block connected via a link providing a certain data rate, wherein:
the first network block comprises at least one data source and at least one data rate limiting means associated with the data source,
the second network block comprises at least one data processing means associated with the data source, and a data flow information obtaining means for obtaining data flow information regarding a data rate of data processed by the data processing means,
wherein the data rate limiting means of the first network block is configured to vary the data rate of data sent from the data source depending on the data flow information.

2. The network element according to claim 1, wherein the data processing means is configured to prepare data for a network interface associated with the data source.

3. The network element according to claim 1, wherein a plurality of data streams are provided and each data stream is associated with one data source and one data rate limiting means of the first network block, and with one data processing means, one data flow information obtaining means and one network interface of the second network block.

4. The network element according to claim 3, wherein the link is a multiplexed link, and the plurality of data streams is transferred via the multiplexed link between the first network block and the second network block.

5. The network element according to claim 4, wherein the multiplexed link is an Ethernet link.

6. The network element according to claim 5, wherein a multiplexing technique applied to the Ethernet link is a Virtual Local Area Network (VLAN) Ethernet.

7. The network element according to claim 1, wherein the data flow information obtaining means comprises a buffering means and a buffer level detecting means, wherein the data flow information comprises information regarding a buffer filling level.

8. The network element according to claim 7, wherein at least a first threshold is provided for the buffer filling level, and the data flow information obtaining means is configured to include information on whether the first threshold is exceeded in the data flow information.

9. The network element according to claim 8, wherein the information on whether the first threshold is exceeded is included in a data flow message and the data flow information obtaining means is configured to send the data flow message only when the first threshold is exceeded.

10. The network element according to claim 8, wherein the data rate limiting means is configured to reduce the data rate in case the first threshold is exceeded.

11. The network element according to claim 7, wherein a second threshold is provided for the buffer filling level, wherein the data flow information obtaining means is configured to include information on whether the buffer filling level has fallen below the second threshold in the data flow information.

12. The network element according to claim 8, wherein a second threshold is provided for the buffer filling level, the second threshold being lower than the first threshold, wherein the data flow information obtaining means is configured to include information on whether the buffer filling level has fallen below the second threshold in the data flow information.

13. The network element according to claim 11, wherein the data flow information obtaining means is configured to include the information on whether the buffer filling level has fallen below the second threshold in a data flow message and to send the data flow message only when the buffer filling level has fallen below the second threshold.

14. The network element according to claim 11, wherein the data rate limiting means is configured to increase the data rate in case the data rate has fallen below the second threshold.

15. A network block comprising at least one data source, at least one data rate limiting means associated with the data source and a data sending means,
wherein the data rate limiting means is configured to vary a data rate of data sent from the data source depending on data flow information.

16. The network block according to claim 15, wherein a plurality of data streams are provided and each data stream is associated with one data source and one data rate limiting means.

17. The network block according to claim 16, wherein the data sending means provides one multiplexed link, and the plurality of data streams is transferred via the multiplexed link.

18. A network block comprising a data receiving means, at least one data processing means for processing received data, and a data flow information obtaining means for obtaining data flow information regarding a data rate,
wherein the data flow information obtaining means is configured to provide the data flow information for varying the data rate.

19. The network block according to claim 18, wherein the data processing means is configured to prepare data for a network interface associated with the data receiving means.

20. The network block according to claim 18, wherein a plurality of data streams are provided and each data stream is associated with one data processing means, one data flow information obtaining means and one network interface.

21. The network block according to claim 20, wherein the data receiving means is connected to one multiplexed link and the plurality of data streams are received via the multiplexed link.

22. The network block according to claim 18, wherein the data flow information obtaining means comprises a buffering means and a buffer level detecting means, wherein the data flow information comprises information regarding a buffer filling level.

23. The network block according to claim 22, wherein at least a first threshold is provided for the buffer filling level, and the data flow information obtaining means is configured to include information on whether the threshold is exceeded in the data flow information.

24. The network block according to claim 23, wherein the information on whether the first threshold is exceeded is included in a data flow message and the data flow information obtaining means is configured to send the data flow message only when the first threshold is exceeded.

25. The network block according to claim 22, wherein a second threshold is provided for the buffer filling level, wherein the data flow information obtaining means is configured to include information on whether the buffer filling level has fallen below the second threshold in the data flow information.

26. The network block according to claim 24, wherein a second threshold is provided for the buffer filling level, the second threshold being lower than the first threshold, wherein the data flow information obtaining means is configured to include information on whether the buffer filling level has fallen below the second threshold in the data flow information.

27. The network block according to claim 25, wherein the information on whether the buffer filling level has fallen below the second threshold is included in a data flow message and the data flow information obtaining means is configured to send the data flow message only when the buffer filling level has fallen below the second threshold.

28. A network system comprising:
a first network block comprising at least one data source, at least one data rate limiting means associated with the data source and a data sending means, wherein the data rate limiting means is configured to vary a data rate of data sent from the data source depending on data flow information; and
a second network block comprising a data receiving means, at least one data processing means for processing received data, and a data flow information obtaining means for obtaining data flow information regarding the data rate, wherein the data flow information obtaining means is configured to provide the data flow information for varying the data rate,
wherein the network blocks are connected via a multiplexed link.

29. A method for controlling data flow from a first network block to a second network block connected via a link providing a certain data rate,
comprising the steps of:
sending data received from a data source of the first network block via the link from the first network block to the second network block;
processing the data received via the link in the second network block;
obtaining data flow information regarding a data rate of the processed data; and
varying the data rate of data sent from the data source of the first network block to the link depending on the data flow information.

30. The method according to claim 29, comprising preparing, in the data processing step, data for a network interface.

31. The method according to claim 29, comprising providing a plurality of data streams, each data stream being associated with one data source and the data rate limiting step, wherein the data processing step and the data flow information obtaining step is performed separately for each data stream.

32. The method according to claim 31, comprising transferring the plurality of data streams via one multiplexed link between the first network block and the second network block.

33. The method according to claim 32, wherein the multiplexed link is an Ethernet link.

34. The method according to claim 33, comprising applying a multiplexing technique to the Ethernet link as a Virtual Local Area Network (VLAN) Ethernet.

35. The method according to claim 29, comprising using a buffering means, in the data flow information obtaining step, wherein the data flow information obtaining step further comprises the step of:
detecting a buffer level, wherein the data flow information is information regarding a buffer filling level.

36. The method according to claim 35, comprising providing at least a first threshold for the buffer filling level, wherein the data flow information comprises information on whether the threshold is exceeded.

37. The method according to claim 36, wherein the data flow information obtaining step further comprises the steps of:
including the information on whether the first threshold is exceeded in a data flow message and
sending the data flow message only when the threshold is exceeded.

38. The method according to claim 36, comprising reducing, in the data rate limiting step, the data rate in case the first threshold is exceeded.

39. The method according to claim 35, comprising providing a second threshold for the buffer filling level, wherein the data flow information comprises information on whether the buffer filling level has fallen below the second threshold.

40. The method according to claim 36, comprising providing a second threshold for the buffer filling level, the second threshold being lower than the first threshold, wherein the data flow information comprises information on whether the buffer filling level has fallen below the second threshold.

41. The method according to claim 39, comprising increasing, in the data rate limiting step, the data rate in case the data rate has fallen below the second threshold.

42. The method according to claim 39, comprising including information on whether the buffer filling level has fallen below the second threshold in a data flow message, wherein the data flow information obtaining means is configured to send the data flow message only when the buffer filling level has fallen below the second threshold.

43. A network element comprising
a first network block and a second network block connected via a multiplexed link providing a certain data rate, wherein
the first network block comprises a plurality of data sources and a plurality of data rate limiting means each being associated with one data source,
the second network block comprises a plurality of data processing means and data flow information obtaining means for obtaining data flow information regarding data rates of data processed by the plurality of data processing means,
wherein a plurality of data streams are provided and each data stream is associated with one data source and one data rate limiting means of the first network block, and with one data processing means, one data flow information obtaining means and one network interface of the second network block, and the plurality of data streams is transferred via the multiplexed link between the first network block and the second network block, and
wherein the data rate limiting means of the first network block are configured to vary the data rates of data sent from each data source depending on the data flow information.

44. The network element according to claim 43, wherein the data processing means are configured to prepare data for network interfaces.

45. A method for controlling data flow from a first network block to a second network block connected via a multiplexed link providing a certain data rate for a plurality of data streams, each data stream being associated with one data source,
the method comprising the steps of:
sending, for each data stream, data received from a data source of the first network block via the multiplexed link from the first network block to the second network block;
processing, for each data stream, data received via the multiplexed link in the second network block;
obtaining, for each data stream, data flow information regarding a data rate of processed data; and
varying, separately for each data stream, the data rate of data sent from the data source of the first network block to the multiplexed link depending on the data flow information.

46. The method according to claim 45, comprising preparing, in the data processing step, data for network interfaces, wherein for each stream one network interface is provided.
